(19) United States
(12) Patent Application Publication
(10) Pub. No.: US 2012/0032760 A1
(43) Pub. Date: Feb. 9, 2012

(54) COMPACT PLANAR RESONATORS WITH Z-AXIS FOLDING

(76) Inventors: Timothy J. Wurth, Liberty Township, OH (US); Jeffrey S. Wells, Liberty Township, OH (US)

(21) Appl. No.: 13/204,950

(22) Filed: Aug. 8, 2011

Related U.S. Application Data
(60) Provisional application No. 61/371,419, filed on Aug. 6, 2010.

(51) Int. Cl. H01P 1/203

(52) U.S. Cl. 333/204

(57) ABSTRACT

A planar filter includes a first ground plate that is formed from a material that is a good conductor of electricity and a first substrate that is formed from a dielectric material disposed adjacent to the first ground plate. The planar filter also includes a second ground plate that is formed from a material that is a good conductor of electricity and a second substrate that is formed from a dielectric material disposed adjacent to the second ground plate. A resonator is formed from a material that is a good conductor of electricity and including a first portion that is disposed adjacent to the first substrate, a second portion that extends from the first portion, and a third portion that extends from the second portion and is disposed adjacent to the second substrate, wherein the first and third portions of the resonator extend in different planes.

### CROSS-REFERENCE TO RELATED APPLICATIONS

This application claims the benefit of United States Provisional Application No. 61/371,419 filed Aug. 6, 2010, the disclosure of which is incorporated herein by reference.

### BACKGROUND OF THE INVENTION

This invention relates in general to filters for electronic circuits. In particular, this invention relates to an improved structure for a planar filter that is compact in size.

Filters are commonly used in electronic circuits for removing undesired frequency components from an electronic signal, enhancing desired frequency components in the electronic signal, or both. Such filters for electronic circuits are typically classified as being either (1) high-pass filters, wherein frequency components below a predetermined level are blocked and frequency components below a predetermined level are passed; (2) low-pass filters, wherein frequency components below a predetermined level are passed and frequency components below a predetermined level are blocked; (3) band-pass filters, wherein frequency components within a predetermined range are passed and frequency components outside of the predetermined range are blocked; and (4) band-reject filters, wherein frequency components within a predetermined range are blocked and frequency components outside of the predetermined range are passed. A wide variety of electronic circuit filter structures of these general types are known in the art.

One well known type of electronic circuit filter is commonly referred to as a planar filter. A typical planar filter is characterized by a relatively narrow strip of an electrically conductive material that functions as a resonator and one or more relatively wide strips of an electrically conductive material that function as a ground plane(s). As is well known, the size, shape, and other characteristics of the resonator define frequency or frequencies at which the planar filter is desired to operate. In a microstrip type of planar filter, the resonator extends parallel to the ground plane, but is separated therefrom by an intervening substrate formed from a dielectric material (i.e., a material that is a poor conductor of electricity). In a stripline type of planar filter, the resonator extends parallel between two ground planes and is separated from each by an intervening dielectric substrate.

Planar filters of this general type find widespread, but not exclusive, use in printed circuit board, with the planar filter designed as part of the printed circuit board because the same techniques and processes used to design and manufacture the printed circuit board can be used to design and manufacture the planar filter. However, it has been found that in some instances, the planar filter can occupy an undesirably large amount of physical space on the printed circuit board. Thus, it would be desirable to provide an improved structure for a planar filter that is compact in size in comparison to equivalent structures.

### SUMMARY OF THE INVENTION

This invention relates to an improved structure for a planar filter that is compact in size in comparison to equivalent structures. The invention provides a technique to reduce the width and length dimensions of a planar resonator by folding the resonator in the Z-axis (i.e., height). This invention permits printed circuit board filters made with planar resonators to have a reduced form factor due to folding the planar resonator. Folding in the plane of the planar filter (defined here as the x-axis and y-axis) has been done for years and abundant prior art exists. This invention folds the planar filter in the z-axis, which may increase the height dimension, but drastically reduces width and length dimensions.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is an exploded perspective view of a prior art structure for a stripline type of planar filter.

FIG. 2 is an enlarged sectional elevational view of a portion of the prior art planar filter illustrated in FIG. 1.

FIG. 3 is an exploded perspective view of an improved structure for a stripline type of planar filter in accordance with this invention.

FIG. 4 is an enlarged sectional elevational view of a portion of the inventive planar filter illustrated in FIG. 13

### DETAILED DESCRIPTION OF THE PREFERRED EMBODIMENT

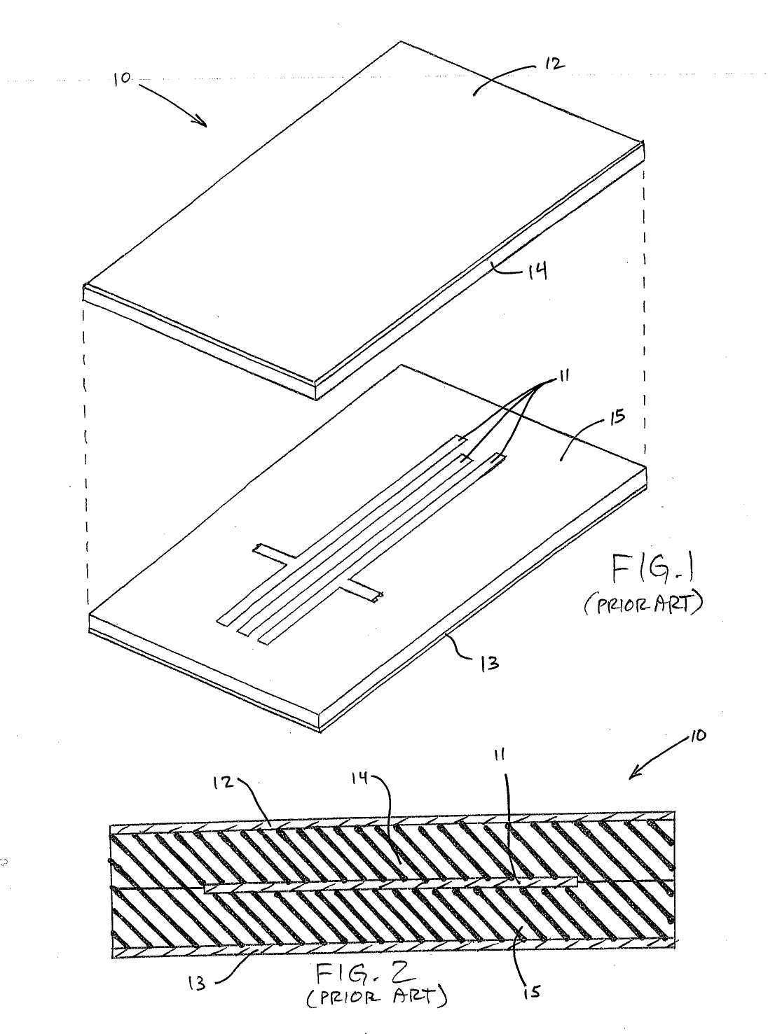

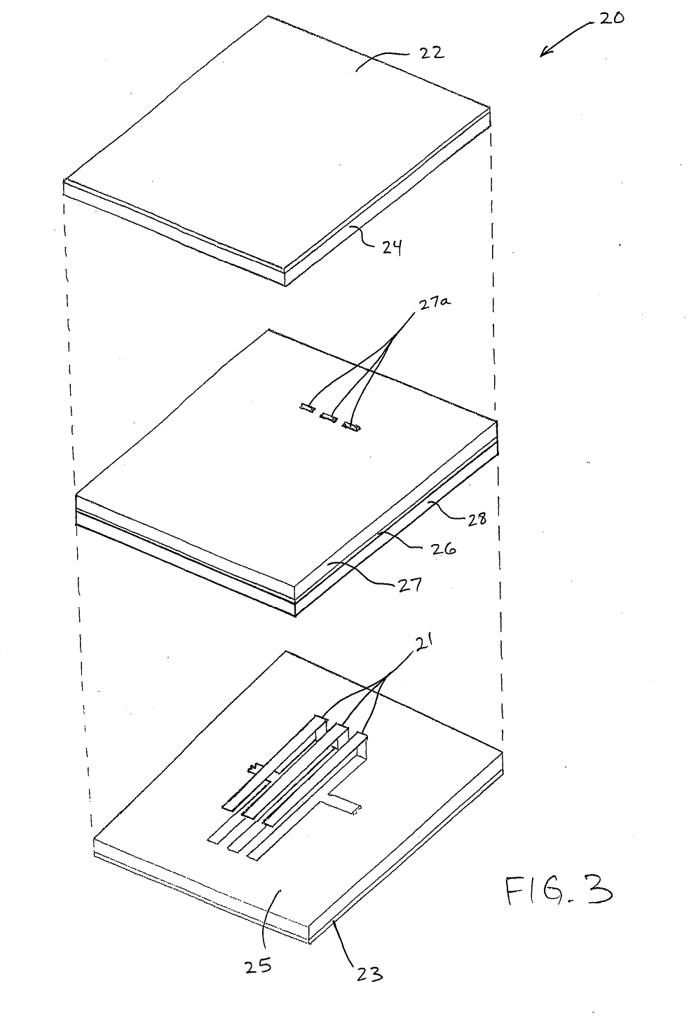

Referring now to the drawings, there is illustrated in FIGS. 1 and 2 a prior art structure for a stripline type of planar filter, indicated generally at 10. The prior art planar filter 10 includes a plurality of resonators 11. Three of such resonators 11 are shown in FIG. 1, although it is known to provide a greater or lesser number thereof. Each of the resonators 11 is flat and elongated in shape and is formed from a material that is a good conductor of electricity, such as a metallic material. In the prior art planar filter 10, each of the resonators 11 extends in a single plane, and all of the resonators 11 are co-planar. As is well known, the size, shape, and other characteristics of the resonator define frequency or frequencies at which the prior art planar filter 10 is desired to operate. For example, the prior art planar filter may be designed to function at ultra high frequencies. The resonators 11 may, for example, be approximately one-quarter of a wavelength at the operating frequency of the planar filter 10, and the length thereof may be approximately 7.9 inches.

The resonators 11 are disposed between a first ground plate 12 and a second ground plate 13. Each of the first and second ground plates 12 and 13 is planar in shape and is formed from a material that is a good conductor of electricity, such as a metallic material. The first ground plate 12 is spaced apart from the resonators 11 by a first substrate 14 that is formed from a dielectric material (i.e., a material that is a poor conductor of electricity). Similarly, the second ground plate 13 is spaced apart from the resonators 11 by a second substrate 15 that is also formed from a dielectric material. When assembled as shown in FIG. 2, the resonators 11, the first and second ground plates 12 and 13, and the first and second ground plates 14 and 15 form the prior art planar filter 10.

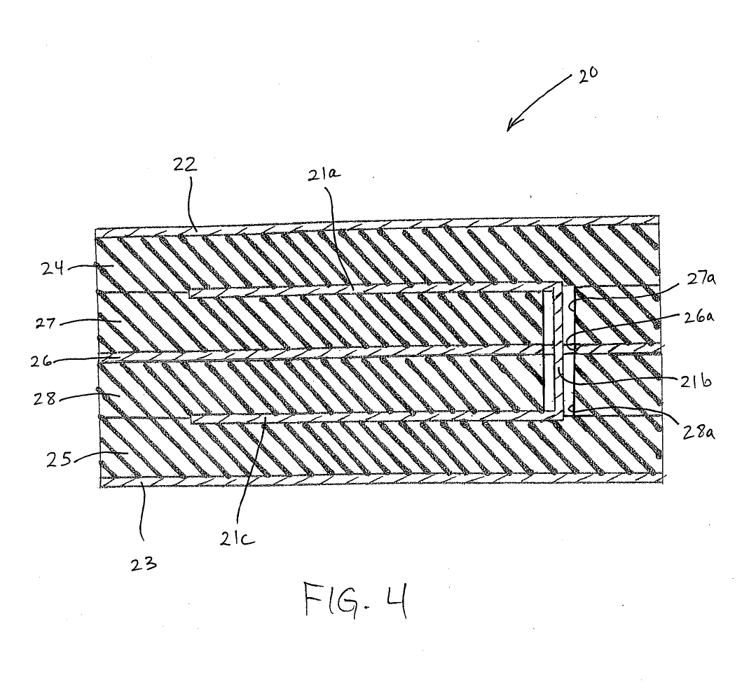

FIGS. 3 and 4 illustrate an improved structure for a planar filter, indicated generally at 20, in accordance with this invention. The planar filter 20 includes a plurality of resonators 21. Three of such resonators 21 are shown in FIG. 1, although this invention may be practiced with a greater or lesser number thereof. Each of the illustrated resonators 21 is elongated in shape and is formed from a material that is a good conductor of electricity, such as a metallic material. As is well known, the size, shape, and other characteristics of the resonator define frequency or frequencies at which the planar filter 20 is desired to operate.

In this invention, none of the resonators 21 extends in a single plane, as do the prior art resonators 11 described above. Rather, each of the resonators 21 extends in two or more planes. As best shown in FIG. 4, each of the resonators 21 includes a first portion 21a that extends in a first plane, a second portion 21b that extends from the first portion 21a and extends in a second plane, and a third portion 21c that extends from the second portion 21b and extends in a third plane. In the illustrated embodiment, the first portions 21a and the third portions 21c of each of the resonators extend in respective planes that are spaced apart and parallel to one another, while the second portions 21b of each of the resonators 21 extend generally perpendicular to the planes defined by the first and third resonators 21a and 21c, respectively. However, each of the resonators 21 may be formed having any other desired shape or combination of shapes.

The resonators 21 are disposed between a first ground plate 22 and a second ground plate 23. Each of the illustrated first and second ground plates 22 and 23 is planar in shape and is formed from a material that is a good conductor of electricity, such as a metallic material. The first ground plate 22 is spaced apart from the first portions 21a of the resonators 21 by a first substrate 24 that is formed from a dielectric material (i.e., a material that is a poor conductor of electricity). Similarly, the second ground plate 23 is spaced apart from the third portions 21c of the resonators 21 by a second substrate 25 that is also formed from a dielectric material.

A third ground plate 26 is disposed between the first portions 21a of the resonators 21 and the third portions 21c of the resonators 21. The illustrated third ground plate 26 is planar in shape and is formed from a material that is a good conductor of electricity, such as a metallic material. The third ground plate 26 is spaced apart from the first portions 21a of the resonators 21 by a third substrate 27 that is formed from a dielectric material. Similarly, the third ground plate 26 is spaced apart from the third portions 21c of the resonators 21 by a fourth substrate 28 that is also formed from a dielectric material.

As shown in FIGS. 3 and 4, the third substrate 27 has a plurality of openings 27a formed therethrough. In the illustrated embodiment, the third substrate 27 has three of such openings 27a formed therethrough, one for each of the three illustrated resonators 21. However, the third substrate 27 may have any desired number of such openings 27a formed therethrough. Similarly, the fourth substrate 28 has a plurality of openings 28a (one of which is illustrated in FIG. 4) formed therethrough. In the illustrated embodiment, the fourth substrate 28 has three of such openings 28a formed therethrough, one for each of the three illustrated resonators 21. However, the fourth substrate 28 may have any desired number of such openings 28a formed therethrough. Lastly, the third ground plate 26 has a plurality of openings 26a (one of which is illustrated in FIG. 4) formed therethrough. In the illustrated embodiment, the third ground plate 26 has three of such openings 26a formed therethrough, one for each of the three illustrated resonators 21. However, the third ground plate 26 may have any desired number of such openings 26a formed therethrough.

As shown in FIG. 4, the openings 26a, 27a, and 28a are provided to allow respective portions of the resonators 21 to extend therethrough. Specifically, the second portions 21b of the resonators 21 extend through the openings 26a, 27a, and 28a to provide electrical continuity between the first and third portions 21a and 21c of the resonators 21. Thus, it can be seen that the first portions 21a of the resonators 21 are disposed between the first and third substrates 24 and 27, respectively, while the third portions 21c of the resonators 21 are disposed between the second and fourth substrates 25 and 28. At the same time, the third ground plate 26 is disposed between third and fourth substrates 27 and 28. When assembled as shown in FIG. 4, the resonators 21, the ground plates 22, 23, and 26, and the substrates 24, 25, 27, and 28 form the planar filter 20 of this invention.

Thus, it can be seen that the resonators 21 of this invention are folded in the lengthwise or elongated direction such that the first and third portions 21a and 21c thereof are aligned in a direction that is perpendicular to the respective planes in which they extend (the vertical direction when viewing FIG. 4). This configuration would not qualify as a stripline type of planar filter 20 without the third ground plane 26 extending between the first and third portions 21a and 21c of the resonators 21. Using the sample dimensions discussed above in connection with the prior art planar filter 10 illustrated in FIGS. 1 and 2, the orientation of the first and third portions 21a and 21c reduces the overall length of the resonators 21 from about 7.9 inches to about 4 inches, which is nearly a 50% reduction in length. This is a significant reduction in size, which would allow the planar filter 20 to be used physical spaces where the prior art planar filter 10 would not be appropriate.

The illustrated planar filter 20 is a stripline type, which is characterized by the resonators extending parallel between the two ground planes and being separated from each by the intervening dielectric substrates. However, it will be appreciated that this invention may be practiced in connection with other types of planar filters 20. For example, this invention could be embodied as a microstrip type of planar filter, wherein the resonators extends parallel to the ground plane, but are separated therefrom by an intervening dielectric substrate.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A planar filter comprising:
a ground plate that is formed from a material that is a good conductor of electricity;
a substrate that is formed from a dielectric material disposed adjacent to the ground plate; and
a resonator that is formed from a material that is a good conductor of electricity disposed adjacent to the substrate, wherein portions of the resonator extend in two or more different planes.

2. The planar filter defined in claim 1 wherein the substrate has an opening formed therethrough, and wherein a portion of the resonator extends through the opening.

3. The planar filter defined in claim 1 wherein the substrate has an opening formed therethrough, and wherein a first portion of the resonator is disposed adjacent to a first side of the substrate, a second portion of the resonator extends through the opening, and a third portion of the resonator is disposed adjacent to a second side of the substrate.

4. The planar filter defined in claim 1 wherein the ground plate is a first ground plate, and wherein the planar filter further includes a second ground plate that is formed from a material that is a good conductor of electricity, the substrate and the resonator being disposed between the first and second ground plates.

5. The planar filter defined in claim 1 wherein the planar filter includes a plurality of resonators that are each formed from a material that is a good conductor of electricity.

6. The planar filter defined in claim 5 wherein each of the resonators extends in two or more different planes.

7. The planar filter defined in claim 1 wherein the substrate has a plurality of openings formed therethrough, and wherein respective portions of each of the resonators extend through the plurality of openings.

8. The planar filter defined in claim 1 wherein the substrate has a plurality of openings formed therethrough, and wherein respective first portions of each of the resonators are disposed adjacent to a first side of the substrate, respective second portions of each of the resonators extend through the openings, and a respective third portions of each of the resonators are disposed adjacent to a second side of the substrate.

9. The planar filter defined in claim 1 wherein the portions of the resonator extends in planes that are parallel to one another.

10. The planar filter defined in claim 1 wherein the portions of the resonator are aligned in a direction that is perpendicular to the respective planes in which they extend.

11. A planar filter comprising:
a first ground plate that is formed from a material that is a good conductor of electricity;
a first substrate that is formed from a dielectric material disposed adjacent to the first ground plate;
a second ground plate that is formed from a material that is a good conductor of electricity;
a second substrate that is formed from a dielectric material disposed adjacent to the second ground plate; and
a resonator that is formed from a material that is a good conductor of electricity and including a first portion that is disposed adjacent to the first substrate, a second portion that extends from the first portion, and a third portion that extends from the second portion and is disposed adjacent to the second substrate, wherein the first and third portions of the resonator extend in different planes.

12. The planar filter defined in claim 11 further including a third ground plate that is disposed between first and third portions of the resonator.

13. The planar filter defined in claim 12 further including a third substrate that is disposed between the first portion of the resonator and the third ground plate.

14. The planar filter defined in claim 13 further including a fourth substrate that is disposed between the second portion of the resonator and the fourth ground plate.

15. The planar filter defined in claim 14 wherein each of the third substrate, the third ground plate, and the fourth substrate has an opening formed therethrough, and wherein the second portion of the resonator extends through each of the openings formed through the third substrate, the third ground plate, and the fourth substrate.

16. The planar filter defined in claim 1 wherein the planar filter includes a plurality of resonators that are each formed from a material that is a good conductor of electricity and that each include a first portion that is disposed adjacent to the first substrate, a second portion that extends from the first portion, and a third portion that extends from the second portion and is disposed adjacent to the second substrate, wherein the first and third portions of the resonator extend in different planes.

17. The planar filter defined in claim 11 wherein the portions of the resonator extends in planes that are parallel to one another.

18. The planar filter defined in claim 11 wherein the portions of the resonator are aligned in a direction that is perpendicular to the respective planes in which they extend.
